(19) United States
(12) Patent Application Publication
(10) Pub. No.: US 2014/0278680 A1
(43) Pub. Date: Sep. 18, 2014

(54) METHOD FOR ALERTING PEOPLE TO EVENTS

(71) Applicant: Yakov Z. Mermelstein, Spring Valley, NY (US)

(72) Inventor: Yakov Z. Mermelstein, Spring Valley, NY (US)

(21) Appl. No.: 14/202,274

(22) Filed: Mar. 10, 2014

Related U.S. Application Data
(63) Continuation-in-part of application No. 13/804,649, filed on Mar. 14, 2013.

(51) Int. Cl. G06Q 10/10

(52) U.S. Cl. CPC G06Q 10/1095
USPC 705/7.19

(57) ABSTRACT

This method involves automatically inserting information about an event onto electronic calendars of persons in a network concurrently with such information being inserted onto an electronic calendar of a member of that network. More particularly, the electronic method of alerting recipients of an event, includes: creating an electronic network of persons for the transmission and sharing of information; entering selected event data onto an electronic calendar of a user who is one of the persons of the electronic network; and, automatically inserting the selected event data onto electronic calendars of other persons in the electronic network without active involvement by the user or the other persons and concurrently with the user entering said selected event data onto the electronic calendar of the user.

### CROSS-REFERENCE TO RELATED APPLICATIONS

The present application claims benefit under 35 U.S.C. 120 of U.S. Non-Provisional application Ser. No. 13/804,649, filed 14 Mar. 2013, and is a continuation-in-part thereof, the entire disclosure of which is incorporated herein by reference.

### FIELD OF THE INVENTION

This invention relates to the electronics and communications industry and, more particularly, to a method for alerting people about something, like events.

### BACKGROUND OF THE INVENTION

With ever increasing frequency, people receive notices about various events. It could be a notice of a private sale at a department store, like Macy's. A Conference notice may be received. It could be an invitation to a party or some special business event. Whatever the event may be, the recipient of the notice needs to have some way to keep track of the event and to know when it will be held.

Therefore, there is a need in the industry for a method to more efficiently alert people about events.

Another aspect of notifying people is even more computer centric. There is a need to alert people to events automatically when a person just enters them on his electronic calendar.

### SUMMARY OF THE INVENTION

These and other objects of the invention are achieved with a method for alerting people about notices. In particular, upon receipt of an electronic notice about an event or something else, the recipient's electronic calendar is automatically updated so as to show the dates of the event or whatever is the subject of the notice.

According to the Invention, the method for alerting people to events, comprises: sending an electronic communication to a preselected group of people; and, Automatically inserting dates, times and locations of a subject matter of the notice on electronic calendars of recipients of said electronic communication.

Another aspect of the invention involves automatically inserting information about an event onto electronic calendars of persons in a network concurrently with such information being inserted onto an electronic calendar of a member of that network.

According to this aspect of the invention, the electronic method of alerting recipients of an event, includes: Creating an electronic network of persons for the transmission and sharing of information; Entering selected event data onto an electronic calendar of a user who is one of the persons of the electronic network; and, Automatically inserting the selected event data onto electronic calendars of other persons in the electronic network without active involvement by the user or the other persons and concurrently with the user entering the selected event data onto the electronic calendar of the user.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention.

The invention will now be described in connection with certain preferred embodiments with reference to the following illustrative figures so that it may be more fully understood.

FIG. 1 is a flow chart, showing the process of the basic invention.

FIG. 2 is a flow chart, showing an additional feature of the process of the invention.

FIG. 3 is a flow chart of an alternate embodiment, showing the process of that invention.

FIG. 4 is a flow chart of another alternate embodiment, showing the process of that invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to the Invention, in its simplest, basic form, it involves, upon receipt of an electronic notice about an event, the recipient's electronic calendar being automatically updated so as to show the dates of the event.

It may be appreciated that the invention preferably refers to events, but it also contemplates notices about anything. The subject matter of the notice is what will be inserted on the electronic calendar, and most frequently it will refer to events.

In the preferred embodiment of the invention (FIG. 1), the method for alerting people to events comprises: sending an electronic communication to a preselected group of people; and automatically inserting dates, times and locations of a subject matter of said notice on electronic calendars of recipients of said electronic communication.

The subject matter of the notice may be anything, including, inter alia, a payment notice, an event notice, a coupon, merchandise return deadlines, warranty information, mortgage payments, credit card payments, and/or payments with due dates.

In the preferred embodiment, the electronic communication includes information about an event, and then the inserting step includes inserting dates, times and locations of the event on electronic calendars of recipients of said electronic communication

Calendaring software is software that minimally provides users with an electronic version of a calendar. Additionally, the software may provide an appointment book, address book, and/or contact list. These tools are an extension of many of the features provided by time management software such as desk accessory packages and computer office automation systems. Calendaring is a standard feature of many PDAs, EDAs, and smart phones.

The software may be a local package designed for individual use or may be a networked package that allows for the sharing of information between users.

The flow of the process is shown in FIG. 1 herein.

Some entity, typically a business, will want to alert people about some activity or event. A department store, like Macy's, may be having a private sale. An organization may be having a convention or conference. The herein invention contemplates a notice of any type of event (even a wedding) from any person or entity or business—either personal or professional or business related. In some cases the notice may be about a deadline of a warranty or a payment date for a utility or something else.

To notify people about the event or activity, some type of electronic notice is send to persons on a distribution list. Typically the communication will be by e mail. Organizations and businesses have electronic address lists. Often they can have thousands or even tens of thousands of persons on it. An e mail blast is generated and all the people on that distribution list receive an e mail about the event, including critical data, like day, time and location.

An Email Blast is an electronic mailing, sent all at once to a large mailing list. This is commonly used by marketers who want to send email advertisements or promotions to their list of customers. They can be a good way to advertise to customers or to quickly notify selected people about some activity or event.

E mail blasts are not new and they are well known.

The novel aspect of the invention concerns what happens when the E mail blast is received.

Upon receipt of the electronic notice, without active involvement of the recipient, the subject matter of the notice, such as, in the preferred embodiment, information about the event, is automatically entered onto his electronic calendar. In this manner, by glancing at his calendar, a person knows about an upcoming event or activity or other requirement, as it is on his calendar.

The main idea here is to have the calendar used and not take up a specific meeting time. What this means is that while the calendar shows the event, it shows it in a background type manner so that the person can still set up meetings, phone calls and other activities which overlap in time.

Therefore, the dates, times and locations of the event may be inserted on the electronic calendars of recipients in a manner which does not interfere with scheduling other activities.

A listing of the event on the electronic calendar may include the number of days left for the event. For example, if the event is a week long, on the 1^{st} daily listing it may say “6 days left”; on the 2^{nd} daily listing it may say “5 days left”; and, on the last daily listing it may say “last day.”

An additional feature is that recipients of the electronic communication can select a specific time and day to attend said event, and it is automatically entered on their electronic calendar. In particular, when the electronic communication is received, all the dates of the event are entered on the recipient's electronic calendar. The recipient can go one step farther if they desire to attend. It is possible for them in one step to open the calendar entry and mark the specific day and time they intend to attend. This works well when they are just attending and do not need to meet anyone.

In some cases, they may choose to respond to the electronic notice to set a specific meeting with a specific person.

According to an additional embodiment (FIG. 2), the method further includes recipients of the electronic communication being able to register for the event. This has several aspects to it.

Registration can be as simple as sending a return e mail to the event holder. On his electronic calendar, a person can click a registration icon, and a registration process is automatically accomplished. This can be based on extracting relevant information about the recipient from his personal electronic device and sending the appropriate and necessary information to the event holder.

Today's ubiquitous personal electronic devices, like smart phones, PDAs, tablets, Ipads, etc, all have internal databases with pre-entered pertinent details of the device owner. These details typically include name, address, e mail, phone number etc.

Therefore, instead of the recipient actively registering for the event, registration for the event occurs automatically once he makes some indication that he wants to attend. When that indication is made, such as by touching a registration icon on his smart phone, the electronic device automatically uploads preselected information about recipient from that internal database and sends it via the Internet to the event holder.

Registration for the event, therefore, comprises automatically uploading preselected information about the recipient from a personal electronic device of the recipient and sending it via said Internet to a event holder.

Another aspect of registration may include completion of a form. These forms may be laid out in a special manner with fields arranged in a known manner. Thus, scanners can read the data quickly and enter it directly into the file of the registrant without human involvement, provided data is entered in the correct field.

When this registration form is received, the recipient's personal electronic device can pull the relevant data from its internal database, such as name, membership number etc, and enter that information in the correct fields on the form. Registration is completed by the electronic return of the form to the event holder. This can now occur without active involvement of the registrant.

Registration for the event, therefore, may also comprise automatically completing a form from the event holder with preselected information about the recipient from the personal electronic device of the recipient; and, automatically returning the form to the event holder.

One additional aspect is that a person after registering may want to alert people that he will be at that event. Here too that can now be automatic. Once the recipient indicates that he will attend the event, automatically without his active involvement an electronic notice is sent to pre-designated persons.

Therefore, registration further comprises automatically sending an electronic notice to pre-designated people that the recipient will be attending said event.

Another aspect of the invention, in its simplest aspect, involves automatically inserting information about an event onto electronic calendars of persons in a network concurrently with such information being inserted onto an electronic calendar of a member of that network.

According to this aspect of the invention (as shown in FIG. 3), the electronic method of alerting recipients of an event, includes: Creating an electronic network of persons for the transmission and sharing of information; Entering selected event data onto an electronic calendar of a user who is one of the persons of the electronic network; and, Automatically inserting the selected event data onto electronic calendars of other persons in the electronic network without active involvement by the user or the other persons and concurrently with the user entering said selected event data onto the electronic calendar of the user.

This Invention involves the concept of everyone being connected and everyone knowing what everyone else is doing.

It contemplates a network of users. This network may be simply a group of friends, or it may be hundreds, thousands or even millions of people. The idea is that all of them want to be connected to each other.

Such networks are known. Facebook is just one example. Hence, there is first creation of an electronic network of persons for the transmission and sharing of information. This information may be of any type at all.

Once this network is created, its members may share information.

In one aspect, a person is desirous of notifying other members of an event, but does not want to trouble himself with an e mail blast or other electronic communications. For example, he may be going to the movies and wants to know who wants to come, but he wants a simple way to find out who is coming

Preferably, the person (i.e. user) enters selected event data onto his electronic. This causes automatic insertion of the selected event data onto electronic calendars of other persons in the electronic network without active involvement by the user or the other persons and concurrently with the user entering the selected event data onto his own electronic calendar.

By this means, instantly once a person enters an event on his electronic calendar, everyone in his network instantly has it on their own electronic calendars. They can now ignore the entry or positively respond and mention that they will also be coming. This allows people to quickly and efficiently “invite” people to events, like going to the movies or a restaurant or a ball game

Preferably, it involves concurrently generating a pop open window upon inserting the selected event data onto electronic calendars of other persons in the electronic network, whereby the persons in the electronic network can accept or decline insertion of the selected event data onto their electronic calendars.

Further, according to a preferred embodiment, responsive to detection of the selected event data in the electronic calendar of the persons of the electronic network, initiating a response by at least one person; and, wherein, the response includes an indication of whether that person will be attending the event, and, if the person is attending the event, automatically inserting that person's attendance onto an electronic calendar in connection with the event.

This allows the initial person to know which other people in the network are going to come and also, in some case, the other people in the network.

Moreover, electronic calendars of other persons in the electronic network identify persons who will be attending said event. By this means, not just the original person, but everyone in the network can see who is coming to the event. This may induce other people to also attend.

In some cases, people in the group may offer changes to the event data, such as day, time, location etc.

More particularly, one of the persons of the electronic network may suggest changes in one or more details of the selected event data; and/or, one of said persons of the electronic network may suggest changes in a time or place of the event.

This allows other people in the network, for example, to suggest a different day, a different movie or maybe a different restaurant. Currently people may get on the phone and call a friend and say “shall we see a certain movie on Tuesday”? Then they call a few other friends to go. One of them says how about Wednesday instead of Tuesday. Another may say Tuesday is okay but mention a different movie. Now, by means of this system, everyone is connected and this back and forth exchange occurs almost instantly by means of their respective electronic calendars.

According to a preferred embodiment of this invention, the method also includes: Monitoring physical locations of persons in electronic network; and Upon a person in the electronic network arriving at a pre-designated destination, automatically inserting onto electronic calendars of persons of electronic network without active participation by the arriving person that the arriving person is currently at the pre-designated destination.

In other words, this method automatically alerts the other people in the network that a person has reached the event.

Monitoring physical locations of persons is now a common well known process. Many people have a smart phone and many smart phones have GPS capability (or some similar technology to identify the location of the device). Just by monitoring the GPS (or location hardware) chip in the smart phone, a person's whereabouts may be instantly determined.

Therefore, monitoring a physical location of a person includes using a means to determine a physical location of a personal electronic device of that person. Today there are a myriad of devices that permit you to precisely determine the location of a person simply by interacting with a hardware module in that person's personal electronic device.

For purposes of the invention, the term portable electronic device includes any portable device that may be used for electronic communication, including, but not limited to, mobile devices, cell phones, smart phones, hand held computers, laptop computers, palm top computers, personal digital assistant (PDA), electronic pads and/or tablets.

The means to determine a physical location may also include any Global Positioning System which also includes any communication system that helps the device determine location, and it is not limited to and may include “WIFI,” “Bluetooth,” “NFC” and/or “GPS.”

Further, the system concurrently generates a pop open window for the arriving person, whereby he can delay notification for a specified time of other persons of the electronic network that the arriving person is currently at the pre-designated destination.

This can be a useful addition. For example a person may arrive, but he is not ready to see the other people. He may, for example, want to get something to eat, or go to the bathroom or attend religious services, and then see the people from his network. By this means, he can delay notifying people that he is there for 30 minutes or some other desired time.

Another feature is that the system may concurrently generate a pop open window upon inserting onto electronic calendars of other persons of the electronic network that the arriving person is currently at the pre-designated destination.

This may be useful because people may not be constantly monitoring their electronic calendars. By this means, they are immediately advised that an entry was made and that the original person creating the event is now there at the event.

Another unique aspect is that the system will automatically create an event when two or more people are present at the same location.

According to this embodiment of the invention, the electronic method includes Monitoring physical locations of persons in the electronic network; and, Upon two or more persons in the electronic network being at the same location, automatically inserting onto electronic calendars of the persons of the electronic network without active participation by these two or more persons that these two or more persons are currently at a specified location.

By this means the whole network learns that at least of their group are at a certain place at a certain time. This allows them to also go if they have an interest.

As stated above, monitoring a physical location of a person includes using a global means to determine a physical location of a personal electronic device of that person.

Pop up windows may also be utilized as explained above.

Hence, the invention includes concurrently generating a pop open window upon inserting onto electronic calendars of the persons of the electronic network that the two or more persons are currently at a specified location. Further, according to the invention, it also includes concurrently generating a pop open window for the two or more persons, whereby they can delay notification for a specified time of the persons of the electronic network that these two or more persons are currently at a specified location.

According to another preferred embodiment of the invention, estimated times of arrival may be included on the electronic calendars.

The invention, therefore, includes Monitoring physical locations of the persons in the electronic network; Calculating when the persons in the electronic network will arrive at a pre-designated destination; and Automatically inserting onto electronic calendars of the persons of the electronic network without active participation by any of the persons the times when the persons in the electronic network will arrive at the pre-designated destination.

As stated above, monitoring a physical location of a person includes using a means to determine a physical location of a personal electronic device of that person.

The GPS capability (or similar technology) not only tells you where a person is located at any point is time, but also identifies their speed and direction of travel. Hence they can also identify when that person will reach a specified destination.

One or more persons of the electronic network may opt to not have their arrival time inserted onto electronic calendars of the persons of the electronic network. This may be due to any number of reasons. One reason may be to surprise people by their appearance. It may also be that they are running late and do not want to broadcast that fact.

To supplement this aspect of the invention, the system includes concurrently generating a pop open window upon inserting onto electronic calendars of the persons of the electronic network the times when persons in the electronic network will arrive at the pre-designated destination. This will make the eta times more noticeable to others.

To build on this concept of defining events, the system may also suggest events. This may either be based on suggestions made by users or be based solely on suggestions from the system.

According to a preferred embodiment, as shown in FIG. 4, this electronic method of defining behavior patterns with respect to events includes: Creating an electronic network of persons for the transmission and sharing of information, each person of the network having means for interfacing with a global positioning system; Continually monitoring physical locations of the persons of the network; Each person of the network maintaining an electronic calendar wherein dates and locations of events being recorded; Maintaining an electronic log of locations persons of the network have visited, including dates and times of day; and Based on the log of locations and the electronic calendars, determining behavior patterns of the persons of the network regarding events.

As stated above, monitoring a physical location of a person includes using a means to determine a physical location of a personal electronic device of that person.

According to this embodiment, each person in the group maintains an electronic calendar. In this electronic calendar, for each day, all of that person's activities are recorded. Hence, it may show lunch at a Deli every Tuesday at 1 o'clock. It may show religious services every day at 1:30 pm, Monday through Friday. Tennis lessons may be shown every Monday and Wednesday at 6 pm. A Office Staff meeting may be shown every Monday at 10 am. In other words, that person's entire daily activities are shown. Not only are recurring events shown, but also things that may occur infrequently or just once or twice.

Over time this electronic calendar tells the life story of the person. By reviewing all its data, a behavioral profile of the person can be built.

Supplementing the electronic calendar is an electronic log of locations persons of the network have visited, including dates and times of day.

By combining the information from the electronic calendar and the electronic log of locations, not only is a behavioral profile of the person defined, but, based on that behavioral profile, one can predict what a person will do in the future.

For example, if it is Tuesday, the system knows that at 1:00pm that person will go to a Kosher Deli for lunch. Thus, if it is 1 pm and he person has not gone yet to the Deli, the system may generate a pop up window on his personal electronic device to mention that it is Tuesday does he want to go to the Deli? The system may be programmed to issue a reminder a certain amount of time in advance—like an hour.

According to this electronic method, a user who is a person of the network may define a desired event and automatically suggesting to the user, based on said behavior patterns, a day, time or location for said desired event. In other words, the user suggests a possible event—like a movie, or going to dinner. Then, based on the behavioral profile, the system may suggest movies of the type that person likes or restaurants that the person frequents.

By automatically suggesting is meant without active participation by said user.

Moreover, suggesting a day, time or location for the desired event includes evaluation of current behavior and external activities involving said desired event. By current behavior of the user is meant evaluating where the person is. If he is traveling in London, obviously suggestions for his hometown of New York will not be made. External activities need to be considered. Where is the movie or restaurant in relation to where the user is. What time does the movie start—is there still time to get to it.

Additionally, as mentioned hereinabove, electronically suggesting to one or more persons of the network that based on behavior patterns, these one or more persons may be interested in creating or attending an event at a defined day, time and location. Here the system is examining everyone's behavioral patterns and calendars. It senses that certain people are situated near a movie theatre, for example, and that a movie is playing of the type that they all like. So, it alerts these people to this possibility.

Similarly, several people may be near a restaurant. That restaurant happens to be of a type they all like and it is a time that each of them normally eats. The system notifies all of them of the possibility of going together to that restaurant.

As above, suggesting of an event includes evaluation of current behavior of one or more persons of the network and external activities involving said event.

Suggesting includes generating a pop open window on a personal electronic device of one or more persons. This way the suggestion is quickly and efficiently brought to their attention.

Event may be of any type including, inter alia, religious services, meals, appointments with professionals, fitness classes, business meetings, family functions.

As mentioned above, electronically suggesting may be concurrent with a time for the event at said the location; or, electronically suggesting may be a predetermined amount of time in advance of a time for the event at the defined location. A person may be told about the event concurrently or could be told a predetermined time in advance, like an hour, 2 hours—whatever time is appropriate.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. An electronic method of alerting recipients of an event, said electronic method comprising the steps of:
a) creating an electronic network of persons for the transmission and sharing of information;
b) entering selected event data onto an electronic calendar of a user who is one of said persons of said electronic network; and
c) automatically inserting said selected event data onto electronic calendars of other persons in said electronic network without active involvement by said user or said other persons and concurrently with said user entering said selected event data onto said electronic calendar of said user.

2. An electronic method according to claim 1, further comprising: concurrently generating a pop open window upon inserting said selected event data onto electronic calendars of other persons in said electronic network, whereby said persons in said electronic network can accept or decline insertion of said selected event data onto their electronic calendars.

3. An electronic method according to claim 1, further comprising: responsive to detection of said selected event data in said electronic calendar of said persons of said electronic network, initiating a response by at least one said person; and, wherein, said response includes an indication of whether said person will be attending said event, and, if said person is attending said event, automatically inserting said person's attendance onto said electronic calendars in connection with said event.

4. An electronic method according to claim 1, further comprising one of said persons of said electronic network suggesting changes in one or more details of selected event data.

5. An electronic method according to claim 1, further comprising
a) monitoring physical locations of said persons in said electronic network; and
b) upon a person in said electronic network arriving at a pre-designated destination, automatically inserting onto electronic calendars of said persons of said electronic network without active participation by said arriving person that said arriving person is currently at said pre-designated destination.

6. An electronic method according to claim 5, further comprising: concurrently generating a pop open window for said arriving person, whereby he can delay notification for a specified time of said persons of said electronic network that said arriving person is currently at said pre-designated destination

7. An electronic method according to claim 5, further comprising: concurrently generating a pop open window upon inserting onto electronic calendars of said persons of said electronic network that said arriving person is currently at said pre-designated destination.

8. An electronic method according to claim 1, further comprising
a) monitoring physical locations of said persons in said electronic network; and
b) upon two or more persons in said electronic network being at the same location, automatically inserting onto electronic calendars of said persons of said electronic network without active participation by said two or more persons that said two or more persons are currently at a specified location.

9. An electronic method according to claim 8, further comprising: concurrently generating a pop open window upon inserting onto electronic calendars of said persons of said electronic network that said two or more persons are currently at a specified location.

10. An electronic method according to claim 8, further comprising: concurrently generating a pop open window for said two or more persons, whereby they can delay notification for a specified time of said persons of said electronic network that said two or more persons are currently at a specified location.

11. An electronic method according to claim 1, further comprising:
a) monitoring physical locations of said persons in said electronic network;
b) calculating when said persons in said electronic network will arrive at a pre-designated destination; and
c) automatically inserting onto electronic calendars of said persons of said electronic network without active participation by any of said persons the times when said persons in said electronic network will arrive at said pre-designated destination.

12. An electronic method according to claim 11, further comprising: one or more persons of said electronic network opting to not have their arrival time inserted onto electronic calendars of said persons of said electronic network.

13. An electronic method according to claim 11, further comprising: concurrently generating a pop open window upon inserting onto electronic calendars of said persons of said electronic network the times when said persons in said electronic network will arrive at said pre-designated destination.

14. An electronic method of defining behavior patterns with respect to events, said electronic method comprising the steps of:
a) creating an electronic network of persons for the transmission and sharing of information, each person of said network having means for interfacing with a global positioning system;
b) continually monitoring physical locations of said persons of said network;
c) each person of said network maintaining an electronic calendar wherein dates and locations of events being recorded;
d) maintaining an electronic log of locations persons of said network have visited, including dates and times of day; and
e) based on said log of locations and said electronic calendars, determining behavior patterns of said persons of said network regarding events.

15. An electronic method according to claim 14, wherein each person of said network having a portable electronic device, and wherein said continually monitoring physical location includes using a means to determine a physical location of said personal electronic devices of said persons of said network.

16. An electronic method according to claim 15, further comprising a user who is a person of said network defining a desired event and automatically suggesting to said user, based on said behavior patterns, a day, time or location for said desired event.

17. An electronic method according to claim 16, wherein said suggesting a day, time or location for said desired event including evaluation of current behavior and external activities involving said desired event.

18. An electronic method according to claim 15, further comprising Electronically suggesting to one or more persons of said network that based on said behavior patterns, said one or more persons may be interested in creating or attending an event at a defined day, time and location.

19. An electronic method according to claim 18, wherein said suggesting of said event including evaluation of current behavior of said one or more persons of said network and external activities involving said event.

20. An electronic method according to claim 18, wherein said suggesting including generating a pop open window on a personal electronic device of said one or more persons.

21. An electronic method according to claim 18, wherein said electronically suggesting being concurrent with a time for said event at said defined location.

22. An electronic method according to claim 18, wherein said electronically suggesting being a predetermined amount of time in advance of a time for said event at said defined location.
